(19) United States
(12) Patent Application Publication
(10) Pub. No.: US 2025/0303788 A1
(43) Pub. Date: Oct. 2, 2025

(54) FULLY CAST IDLER WHEEL

(71) Applicant: Caterpillar Inc., 100 NE Adams Street, IL (US)

(72) Inventors: Brian B. UMBACH, Peoria, IL (US); Martin Tagore Joseph Xavier, Tamil Nadu (IN); Anvesh TIWARI, Chennai (IN)

(73) Assignee: Caterpillar Inc., Peoria, IL (US)

(21) Appl. No.: 18/620,794

(22) Filed: Mar. 28, 2024

(51) Int. Cl. B60B 15/02

(52) U.S. Cl. CPC B60B 15/02; B60B 2310/202

(57) ABSTRACT

A fully cast idler wheel may include an annular rim portion, an annular hub portion, and a plurality of beams extending between the annular rim portion and the annular hub portion. The plurality of beams may include a first set of beams and a second set of beams that extend between the annular rim portion and the annular hub portion on opposite axial sides of the fully cast idler wheel. Both the first set of beams and the second set of beams may be offset from each other both axially and circumferentially.

### TECHNICAL FIELD

The present disclosure relates generally to an idler wheel for a mobile industrial machine, and more particularly, to a fully cast idler wheel.

### BACKGROUND

Track-type machines are used in a wide variety of rugged environments. These track-type machines incorporate ground-engaging tracks, rather than a plurality of wheels, in order to provide enhanced traction, stability, and robustness to the mobile industrial machine. Mining, construction, landfills, forestry, and still other service environments are notable examples of terrains where track-type machines are advantageously used. A typical undercarriage system in a track-type machine may include a plurality of track links coupled together in a continuous or endless track chain, and extending about a drive sprocket and one or more rotatable idler wheels. During operation of the track-type machine, the one or more idler wheels may experience dynamic loading, which in turn may translate to additional stresses and forces placed on the idler wheel. Suboptimal distribution of these forces within the idler wheel may result in the premature failure of the idler wheel and shorten its service life.

As idler wheel designs may be standardized across different industrial machines in order to be mass produced, it is desirable that the idler wheels possess adequate durability and robustness without incurring increased manufacturing costs and component weight. For example, an overbuilt idler wheel may be sufficiently durable and robust to allay any concerns of structural failure, but may result in a suboptimal weight due to the use of excessive material and in increased manufacturing costs, thereby making the design cost prohibitive. Accordingly, it is desirable to form an idler wheel with appropriate strength, durability, weight, and cost of the idler wheel.

An exemplary wheel is disclosed in Japanese Patent Publication No. 2013078770 A (“the '770 publication”) to Ono et al. The '770 publication discloses the use of a wheel that includes a disk portion with an inner rim portion provided at the periphery of the disk portion and an outer rim portion. The '770 publication further notes that, to distribute the weight of a vehicle, a plurality of spoke portions extend between the outer rim portion and the inner rim portion. The wheel provided in the '770 publication is produced using a forged billet of a light metal alloy such as duralumin, and shaping and machining the billet to a final product. Such a manufacturing process may be, among other things, labor intensive and expensive.

The fully cast idler wheel of the present disclosure may solve one or more of the problems set forth above and/or other problems in the art. The scope of the current disclosure, however, is defined by the attached claims, and not by the ability to solve any specific problem.

### SUMMARY

In one aspect, a fully cast idler wheel includes an annular rim portion; an annular hub portion; and a plurality of beams extending between the annular rim portion and the annular hub portion. The plurality of beams include a first set of beams extending between the annular rim portion and the annular hub portion on a first axial side of the fully cast idler wheel and a second set of beams extending between the annular rim portion and the annular hub portion on a second, opposite axial side of the fully cast idler wheel. The first set of beams of the fully cast idler wheel are axially offset from the second set of beams of the fully cast idler wheel.

In another aspect, a fully cast idler wheel for an undercarriage assembly of a mobile industrial machine includes an annular rim portion; an annular hub portion; and a plurality of beams. The plurality of beams include a first set of beams extending between the annular rim portion and the annular hub portion on a first axial side of the fully cast idler wheel and a second set of beams extending between the annular rim portion and the annular hub portion on a second, opposite axial side of the fully cast idler wheel. The first set of beams and the second set of beams of the fully cast idler wheel each include a plurality of substantially-V shaped beams that extend between the annular hub portion and the annular rim portion.

In yet another aspect, a fully cast idler wheel for an industrial undercarriage assembly includes an annular rim portion, an annular hub portion, a first set of beams, and a second set of beams. The first set of beams and the second set of beams each include four substantially V-shaped beams that extend between the annular hub portion and the annular rim portion, and the first set of beams and the second set of beams are circumferentially offset from each other at an approximately 45 degree angle.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a portion of a mobile industrial machine having an idler wheel, according to aspects of the disclosure.

FIG. 2A is an isometric view of the exemplary idler wheel of FIG. 1.

FIG. 2B is an isometric cross-sectional view of the exemplary idler wheel of FIG. 2A.

FIG. 3A is a side view of the exemplary idler wheel of FIG. 1.

FIG. 3B is a cross-sectional view of the exemplary idler wheel of FIG. 3A.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

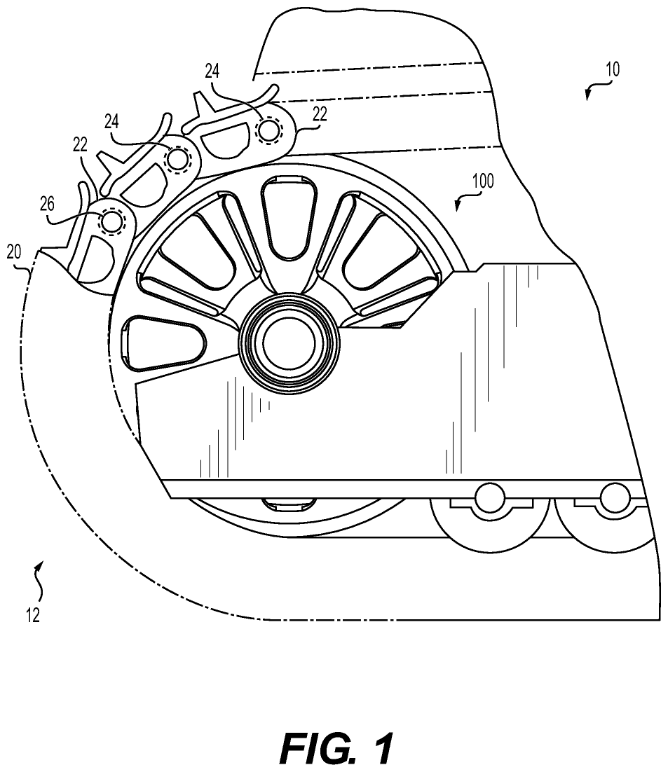

FIG. 1 illustrates a partial view of a mobile industrial machine 10, including a portion of an undercarriage assembly 12 and a ground-engaging track 20. The mobile industrial machine 10 may be any of various mobile machines that employ track assemblies for ground transportation and/or for mobility during machine operation. For example, mobile industrial machine 10 may be a track-type tractor, skid steer, dozer, excavator, track loader, front shovel, rope shovel, or any other type of track maneuverable machine. While only a portion of undercarriage assembly 12 is shown in FIG. 1, it will be understood that, in addition to an exemplary idler wheel 100, the undercarriage would further include a drive sprocket (not shown), one or more additional idler wheels (not shown), and other generally conventional track components.

Further, the ground-engaging track 20 may include a plurality of track links 22 with an integral track bushing 24. The plurality of track links 22 may be connected together by a plurality of transverse track pins 26, which extend through the integral track bushings 24, to create a continuous or endless loop. The continuous loop of the ground-engaging track 20 is formed about the idler wheel 100, the drive sprocket (not shown), and the one or more additional idler wheels (not shown) of the undercarriage assembly 12. The track links 22 may engage with aspects of the idler wheel 100, although other configurations, such as engagement with the track bushings 24, are possible. During operation, the drive sprocket (not shown) may be driven by a power source or engine (not shown) to engage track links 22 and cause movement of the ground-engaging track 20.

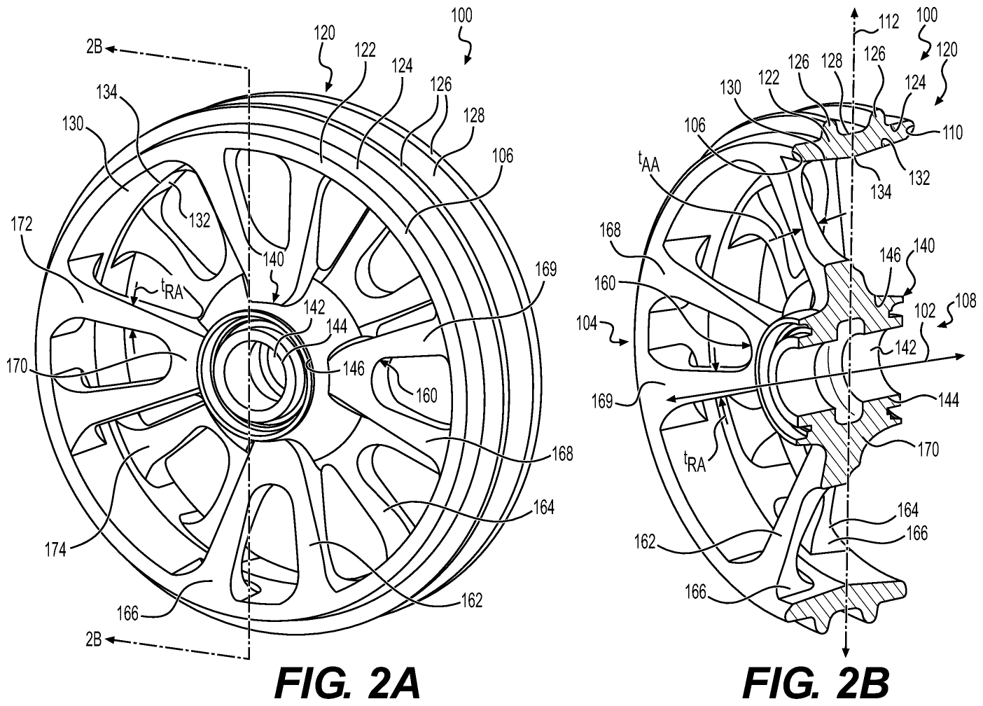

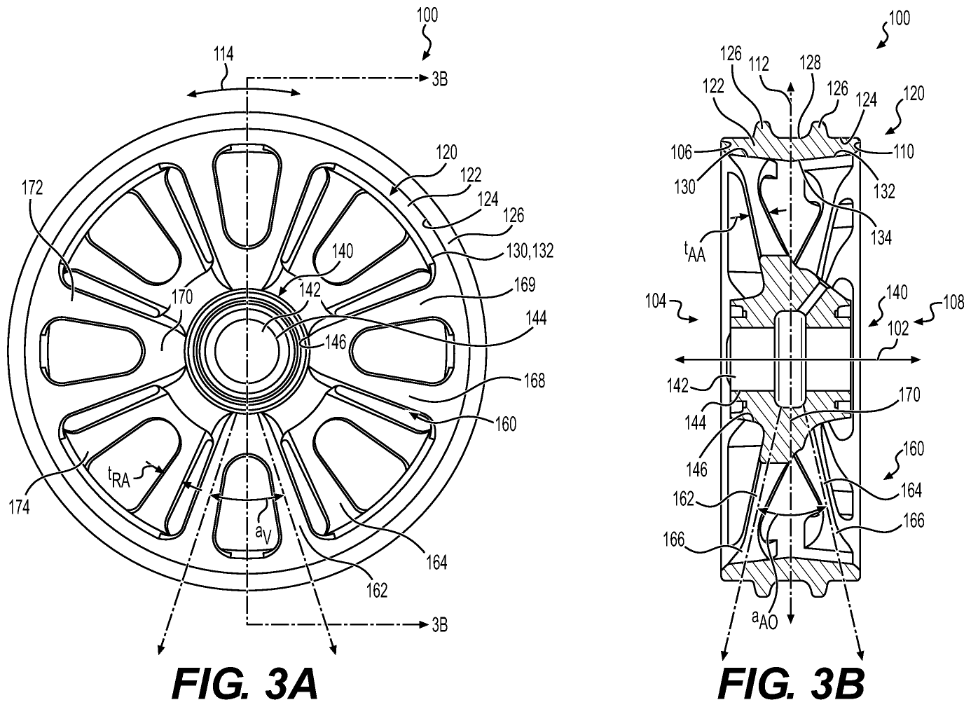

FIGS. 2A-2B and 3A-3B depict various views of the fully cast idler wheel 100 in accordance with the present disclosure. The idler wheel 100 includes an annular rim portion 120, an annular hub portion 140, and a plurality of beams, spokes, or members 160. It should be noted that the idler wheel 100 may be described in terms of an axial axis 102, a radial or central vertical axis 112, and a circumferential direction 114. The axial axis 102 extends horizontally through the idler wheel 100 (shown in FIGS. 2B and 3B), specifically through the annular hub portion 140, and defines a first axial side 104 and a second axial side 108 (shown in FIGS. 2B and 3B). The radial or central vertical axis 112 extends vertically through and bisects the idler wheel 100 (shown in FIGS. 2B and 3B). Finally, the circumferential direction 114 corresponds to a rotational direction as it relates to an outer circumference of the idler wheel 100 (shown in FIG. 3A).

The annular rim portion 120, shown in FIGS. 2A-2B and 3A-3B, includes an annular or tubular body 122 that is generally symmetrical about the axial axis 102. The annular body 122 extends between a first axial edge 106 and a second axial edge 110 of the idler wheel 100. The annular body 122 also includes a radially outer rim surface 124 with a pair of protrusions 126 and a pair of radially inner rim surfaces 130, 132 that face generally towards the annular hub portion 140 (shown in FIGS. 2B and 3B). The pair of protrusions 126 extend radially outward from the radially outer rim surface 124 and encompass the full external circumference of the idler wheel 100. The protrusions 126 are spaced axially inward from the first and second axial edges 106, 110 (shown in FIGS. 2B and 3B), forming a medial trough 128 on the radially outer rim surface 124 of the idler wheel 100. The pair of protrusions 126, together with the medial trough 128, may be contoured as desired for engagement with the ground-engaging track 20 and/or the track links 22.

Within the annular rim portion 120, the annular body 122 includes an internal ridgeline 134 that is centered on the radial axis 112 (shown in FIGS. 2B and 3B) and is flanked on either side by the pair of radially inner rim surfaces 130, 132 (shown in FIGS. 2B and 3B). As shown in FIGS. 2B and 3B, the internal ridgeline 134 is raised radially inward towards the annular hub portion 140, with the radially inner rim surfaces 130, 132 extending radially outward to the first and second axial edges 106, 110 of the idler wheel 100. The outward radial extension of the radially inner rim surfaces 130, 132 towards the first and second axial edges 106, 110 provides opposing sloped surfaces, as viewed in the cross-sectional FIG. 3B.

The annular hub portion 140 is positioned radially inwardly from the annular rim portion 120, as shown in FIGS. 2A-2B and 3A-3B. The annular hub portion 140 includes a radially outer hub surface 146 and a central bore 142 extending therethrough. While a radially inner hub surface 144 of the central bore 142 may be positioned about an axle (not shown) for rotation, the radially outer hub surface 146 may gradually transition into the plurality of beams 160. Each of the individual beams 160 are axially narrower than either of the annular hub portion 140 or the annular rim portion 120. The plurality of beams 160 extend from the annular hub portion 140 to the annular rim portion 120. The plurality of beams may also include multiple filleted or rounded corners 166 at an end of the beams 160 proximal to the annular rim portion 120. Furthermore, the plurality of beams 160 may be integrally formed with the annular hub portion 140 and/or the annular rim portion 120. For example, the idler wheel 100 may be cast from a single material, such as a high-strength steel alloy, while, in other embodiments, the idler wheel 100 may be formed by fabricating, forging, stamping, punching, or the like.

The plurality of beams 160 may include two sets of beams 162, 164 located on opposite sides of the radial or central vertical axis 112 (shown in FIGS. 2B and 3B), with a first set of beams 162 located on a first axial side 104 and a second set of beams 164 located on a second axial side 108. Both the first set of beams 162 and the second set of beams 164 include a pair of individual arms 168, 169 forming a generally V-shape beam 160 with a vertex 170 that is adjacent to and integrally formed with the radially outer hub surface 146 of the annular hub portion 140. The individual arms 168, 169 of the V-shape beams 160 extend radially and circumferentially outward from the vertex 170 to the annular rim portion 120 to form a vertex angle a_{V} (shown in FIG. 3A) that ranges from approximately 25 to 35 degrees. More specifically, the vertex angle a_{V} measures a circumferential portion of the annular rim portion 120 relative to the axial axis 102 (FIG. 3A) that is centrally located within the central bore 142 and, in some configurations, the vertex angle a_{V} may be 30 degrees or approximately 30 degrees. Additionally, the V-shaped beams 160 may be substantially identical to one another, including V-shaped beams 160 in different sets of beams 162, 164. For example, as shown in FIGS. 2A and 3A, the first set of beams 162 may include four substantially V-shaped beams 160 that are substantially identical to the four substantially V-shaped beams 160 included in the second set of beams 164.

Furthermore, the V-shaped beams 160 of the first and second sets of beams 162, 164 are positioned in a spaced configuration, as shown in FIGS. 2A and 3A. In this spaced configuration, the V-shaped beams 160 of the first set 162 are spaced circumferentially apart or offset from the V-shaped beams 160 of the second set 164, thereby distributing loads evenly between the annular rim portion 120 and the annular hub portion 140. In the exemplary spaced configuration (FIGS. 2A and 3A), the V-shaped beams 160 of the first set of beams 162 and the second set of beams 164 are circumferentially offset from each other at an approximately 45 degree angle, as measured from a leading arm 172 of an individual V-shaped beam 160 to a leading arm 174 of an adjacent V-shaped beam 160 in the opposite set (e.g., the first set of beams 162 or the second set of beams 164, respectively). This circumferential spacing is repeated so that the V-shaped beams 160 are evenly spaced along the circumferences of the annular rim portion 120 and the annular hub portion 140. However, it should be noted that, in alternative embodiments (not shown), the first and second sets of beams 162,164 may include additional or fewer numbers of V-shaped beams 160 with different spacing configurations, as dictated by the needs of the user.

The pair of arms 168, 169 of the V-shaped beams 160 may also include bi-directional tapering along the length of the arms 168, 169. As shown in FIGS. 2A, 2B, and 3A, the pair of arms 168, 169 may include a radial arm thickness t_{RA}. As the arms 168, 169 extend from the annular hub portion 140 radially outward to the annular rim portion 120, the radial arm thickness t_{RA} increases in size, ranging from approximately 23.5 to approximately 37 millimeters in thickness. For example, as shown in FIG. 3A, the radial arm thickness for an end of the pair of arms 168, 169 located proximal to the annular hub portion 140 is less than the radial arm thickness for an end of the pair of arms 168, 169 located proximal to the annular rim portion 120. Furthermore, it should be noted that each of the V-shaped beams 160 would include a similar radial tapering, such that each V-shaped beams 160 increases in size as the V-shaped beam 160 extends radially outward from the annular hub portion 140 to the annular rim portion 120. In addition to tapering radially, the V-shaped beams 160, including the pair of arms 168, 169 (FIG. 3A), taper in an axial direction, resulting in matching axial thickness measurements for the V-shaped beams 160 and the pair of arms 168, 169. For example, in FIG. 3B, the plurality of V-shaped beams 160 include an axial arm thickness t_{AA} that decreases in size as the plurality of V-shaped beams 160 extend from the annular hub portion 140 toward the filleted corners 166 and the annular rim portion 120, such that the axial arm thickness proximal to the annular hub portion 140 is greater than the arm beam thickness proximal to the annular rim portion 120. As such, the axial arm thickness t_{AA} may range from approximately 19 to approximately 36 millimeters in thickness.

As noted above, the ends of the plurality of V-shaped beams 160 proximal to the annular rim portion 120 may be axially offset from each other about opposite sides of the radial axis 112. For example, as shown in FIG. 3B, the ends of the first set of beams 162 on the first axial side 104 are axially offset from the ends of the second set of beams 164 on the second axial side 108 where the respective ends connect to the annular rim portion 120. The first set and second set of beams 162, 164 form an axial offset angle dao that measures the distance between the sets of beams 162, 164 located on opposite sides 104, 108 of the radial or central vertical axis 112. The angle vertex of the axial offset angle a_{AO} is located proximal to the annular hub portion 140 and the axial offset angle a_{AO} extending radially outward towards the annular rim portion 120. The axial offset angle a_{AO} may range from approximately 40 to 60 degrees. However, in some configurations, the axial offset angle a_{AO} may be 50 degrees or approximately 50 degrees.

### INDUSTRIAL APPLICABILITY

The disclosed aspects of the fully cast idler wheel 100 of the present disclosure may be used with an undercarriage assembly 12 and on various mobile industrial machines that include such a tracked undercarriage. The fully cast idler wheel 100, as described herein, may provide a lightweight, durable, and cost-effective alternative to fabricated idlers, while increasing performance, reducing the risk of deformation, and limiting the potential need of maintenance or replacement of the component. In the event that a replacement of the fully cast idler wheel 100 is required, the idler wheel 100 may minimize the replacement costs and the amount of material required, while providing appropriate strength of the idler wheel 100.

The fully cast idler wheel 100 of the present disclosure may be manufactured via an industrial casting process, resulting in an idler wheel 100 of unitary construction. The casting process of the idler wheel 100 may include multiple steps, including a step of creating a pattern based on the final idler wheel 100 and generating a reusable industrial mold. Next, the casting process may include a step of heating a high-strength steel alloy until the metal is in a liquid form. In the subsequent step of casting, the molten metal is poured into the reusable industrial mold and cooled. Once the cast idler wheel 100 has cooled and fully solidified, the method may include finishing the idler wheel 100, which may including filing, polishing and otherwise machining the cast idler wheel to remove any excess material or imperfections from the finished product. The resulting idler wheel 100 may thus be made of a monolithic steel material, without the use of welding or other means of fastening or attachment.

In accordance with the present disclosure, the fully cast idler wheel 100 may help minimizes the overall weight of the individual component while helping to provide appropriate strength of the overall design. By utilizing a cast design, the idler wheel 100 may reduce the amount of materials utilized in the fabrication of individual idler wheels 100 and eliminate the use of welding and/or the use of fabricated components. The idler wheel 100 may be mass produced cost effectively with a high degree of durability, while using less materials.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A fully cast idler wheel, comprising:
an annular rim portion;
an annular hub portion; and
a plurality of beams extending between the annular rim portion and the annular hub portion, the plurality of beams including:
a first set of beams extending between the annular rim portion and the annular hub portion on a first axial side of the fully cast idler wheel; and
a second set of beams extending between the annular rim portion and the annular hub portion on a second, opposite axial side of the fully cast idler wheel,
wherein the first set of beams of the fully cast idler wheel is axially offset from the second set of beams of the fully cast idler wheel.

2. The fully cast idler wheel of claim 1, the fully cast idler wheel including a central vertical axis, wherein the first set of beams and the second set of beams are located on opposite sides of the central vertical axis.

3. The fully cast idler wheel of claim 2, wherein the first set of beams and the second set of beams extend radially outward from the annular hub portion about either side of the central vertical axis and together form an axial angle a_{AO}, wherein the axial angle a_{AO} ranges from approximately 40 to 60 degrees.

4. The fully cast idler wheel of claim 1, wherein the first set of beams and the second set of beams each include a plurality of substantially V-shaped beams, each with a pair of arms that extend between the annular hub portion and the annular rim portion.

5. The fully cast idler wheel of claim 4, wherein the pairs of arms each form a vertex adjacent to a radial outer surface of the annular hub portion and extend radially and circumferentially outward from the vertex to the annular rim portion.

6. The fully cast idler wheel of claim 4, wherein the plurality of substantially V-shaped beams of the first set of beams are substantially identical to the plurality of substantially V-shaped beams of the second set of beams.

7. The fully cast idler wheel of claim 4, wherein the pairs of arms together form a vertex angle aᵥ ranging from approximately 25 to 35 degrees.

8. The fully cast idler wheel of claim 4, wherein the first set of beams includes four substantially V-shaped beams and the second set of beams includes four substantially V-shaped beams,
wherein the first set of beams and the second set of beams are circumferentially offset from each other at an approximately 45 degree angle.

9. The fully cast idler wheel of claim 4, wherein the pairs of arms each include a radial arm thickness that increases as the pairs of arms extend from the annular hub portion radially outward to the annular rim portion.

10. The fully cast idler wheel of claim 9, wherein the pairs of arms each include an axial arm thickness that decreases as the pairs of arms extend from the annular hub portion radially outward to the annular rim portion.

11. A fully cast idler wheel for an undercarriage assembly of a mobile industrial machine, the fully cast idler wheel comprising:
an annular rim portion;
an annular hub portion; and
a plurality of beams including:
a first set of beams extending between the annular rim portion and the annular hub portion on a first axial side of the fully cast idler wheel; and
a second set of beams extending between the annular rim portion and the annular hub portion on a second, opposite axial side of the fully cast idler wheel,
wherein the first set of beams and the second set of beams of the fully cast idler wheel each include a plurality of substantially-V shaped beams that extend between the annular hub portion and the annular rim portion.

12. The fully cast idler wheel of claim 11, the plurality of substantially-V shaped beams each including a pair of arms extending between the annular hub portion and the annular rim portion,
wherein the pairs of arms each include an axial arm thickness that decreases as the pairs of arms extend from the annular hub portion radially outward to the annular rim portion.

13. The fully cast idler wheel of claim 11, wherein the first set of beams includes four substantially V-shaped beams and the second set of beams includes four substantially V-shaped beams,
wherein the first set of beams and the second set of beams are circumferentially offset from each other at an approximately 45 degree angle.

14. The fully cast idler wheel of claim 11, the fully cast idler wheel including a central vertical axis, wherein the first set of beams and the second set of beams are axially offset from the central vertical axis.

15. The fully cast idler wheel of claim 12, wherein the pair of arms of the plurality of beams each include a radial arm thickness that increases as the pairs of arms extend from the annular hub portion radially outward to the annular rim portion.

16. A fully cast idler wheel for an industrial undercarriage assembly, the fully cast idler wheel comprising:
an annular rim portion;
an annular hub portion;
a first set of beams, wherein the first set of beams include four substantially V-shaped beams that extend between the annular hub portion and the annular rim portion; and
a second set of beams, wherein the second set of beams include four substantially V-shaped beams that extend between the annular hub portion and the annular rim portion,
wherein the first set of beams and the second set of beams of the fully cast idler wheel are circumferentially offset from each other at an approximately 45 degree angle.

17. The fully cast idler wheel of claim 16, the fully cast idler wheel including a central vertical axis, wherein the first set of beams and the second set of beams extend radially outward from the annular hub portion about either side of the central vertical axis and together form an axial angle a_{AO}, wherein the axial angle a_{AO} ranges from approximately 40 to 60 degrees.

18. The fully cast idler wheel of claim 16, the plurality of substantially V-shaped beams of the first set of beams and the second set of beams each including a pair of arms extending between the annular hub portion and the annular rim portion,
wherein the pairs of arms of the first set of beams and the second set of beams each include a radial arm thickness that increases as the pairs of arms extend from the annular hub portion radially outward to the annular rim portion.

19. The fully cast idler wheel of claim 18, wherein the pairs of arms of the first set of beams and the second set of beams each include an axial arm thickness that decreases as the pairs of arms extend from the annular hub portion radially outward to the annular rim portion.

20. The fully cast idler wheel of claim 18, the pairs of arms of the first set of beams and the second set of beams each form a vertex adjacent to a radial outer surface of the annular hub portion and extend radially and circumferentially outward from the vertex,
wherein each of the pairs of arms together form a vertex angle aᵥ ranging from approximately 25 to 35 degrees.
